(19) United States
(12) Patent Application Publication
(10) Pub. No.: US 2013/0339156 A1
(43) Pub. Date: Dec. 19, 2013

(54) Method and Apparatus for Selecting an Advertisement for Display on a Digital Sign According to an Approaching Object

(71) Applicants: Addicam V. Sanjay, Gilbert, AZ (US); Shahzad A. Malik, Ottawa (CA); Abhishek Ranjan, Toronto (CA); Shweta Phadnis, Chandler, AZ (US); Jose A. Avalos, Chandler, AZ (US)

(72) Inventors: Addicam V. Sanjay, Gilbert, AZ (US); Shahzad A. Malik, Ottawa (CA); Abhishek Ranjan, Toronto (CA); Shweta Phadnis, Chandler, AZ (US); Jose A. Avalos, Chandler, AZ (US)

(21) Appl. No.: 13/976,367

(22) PCT Filed: Apr. 5, 2012
(86) PCT No.: PCT/US12/32417

§ 371 Date: Sep. 4, 2013

(51) Int. Cl. G06Q 30/02

(52) U.S. Cl. CPC G06Q 30/0269
USPC 705/14.66

(57) ABSTRACT

Selecting when to display one of a plurality of advertisements on a digital sign. An embodiment of the invention gathers video analytics data from a plurality of objects that pass by a sensor, and analyze the gathered video analytics data to determine a type for each of the objects. The embodiment then trains advertising models based on the determined types and selects an advertisement from a plurality of advertisements for display on the digital sign based on the trained advertising models.

### TECHNICAL FIELD

Embodiments of the invention relate to a system for selecting, or targeting, when advertising is to be displayed on a digital display device based on an approaching object and associated viewer.

### BACKGROUND ART

Digital signage is the term that is often used to describe the use of an electronic display device, such as a Liquid Crystal Display (LCD), Light Emitting Diode (LED) display, plasma display, or a projected display to show news, advertisements, local announcements, and other multimedia content in public venues such as public billboards, restaurants or shopping malls. In recent years, the digital signage industry has experienced tremendous growth, and it is now only second to the Internet advertising industry in terms of annual revenue growth.

Targeted advertising involves selecting the time and location for an advertisement (“ad”) to be displayed to a potential audience member or viewer based on various factors such as demographics, purchase history, or observed viewing behavior. Targeted advertising helps to identify a potential viewer, and improves advertisers' Return on Investment (ROI) by providing timely and relevant advertisement to the potential viewer. Targeted advertising in the digital signage industry involves digital signs that have the capability to dynamically select and play advertisements according to the traits or actions of the potential viewer in front of the digital signs.

What is needed is a way to identify patterns in viewing behavior or location so that ad content can be targeted and adapted to the specific demographics of the people viewing the ad content.

### BRIEF DESCRIPTION OF THE DRAWINGS

Embodiments of the present invention will be understood more fully from the detailed description given below and from the accompanying drawings of various embodiments of the invention, which, however, should not be taken to limit the invention to the specific embodiments, but are for explanation and understanding only.

FIG. 1 illustrates in functional block form an embodiment of the invention.

FIG. 2 is a flow chart of an embodiment of the invention.

FIG. 3 illustrates aspects of an embodiment of the invention.

FIG. 4 provides a block diagram of a content management system in accordance with an embodiment of the invention.

FIG. 5 provides a block diagram of a digital sign module in accordance with an embodiment of the invention.

FIG. 6 is a flow chart of an embodiment of the invention.

### DESCRIPTION OF THE EMBODIMENTS

Video Analytics (VA) is a passive and automated audience or viewer measurement technology designed for digital signage networks that can be used to provide digital signage operators with quantitative viewership information and return on investment (ROI) data. Embodiments of the present invention use VA data and data mining techniques to achieve targeted advertising, which can be used to measure and improve the advertising ROI of a digital sign.

Embodiments of the present invention make use of video analytics (VA) in displaying advertising on a digital sign comprising a digital display screen or device. By providing digital signs access to a sensor, such as one or more front-facing cameras proximate the digital display device, and VA software coupled with processors, such as Intel Core I5 and Intel Core I7 processors, digital signs according to an embodiment of the invention have the intelligence to detect the number of viewers, their gender, their age bracket, and object associated with the viewers, and then adapt ad content based on one or more pieces of that information. For example, if a viewer is a teenage girl, then an embodiment of the invention may change the content to highlight a back to school shoe promotion a few stores down from where the digital display screen is presently located. If the viewer is a senior male, then an embodiment may cause the digital display screen to display an advertisement about a golf club sale at a nearby sporting goods store. If the viewer is wearing a pair of shoes, a baseball cap, or a shirt, with a logo, then an embodiment may cause a digital display screen to display an advertisement at a nearby store that is perhaps of interest to the viewer. As used herein, the term logo refers to a graphic mark or emblem commonly used by commercial enterprises, organizations, or individuals to aid and promote instant public recognition. Logos may be either graphic (symbols/icons) or are composed of the name of the organization.

Embodiments of the invention involve targeted advertising in which future viewers or customers belonging to the same or similar demographic as previous viewers are targeted based on the viewing behavior or patterns of the previous viewers. Other embodiments detect objects associated with viewers or on their persons at a particular location and time, and then target advertising to the viewers at the same or a different location and time. By analyzing VA or objects associated with viewers, or collected from viewers positioned in front of a digital display device, embodiments can discover patterns, such as viewing patterns, and use this information to train advertising models that can be deployed to the digital sign. These advertising models can then be used to choose specific advertisements from the inventory of available advertising content to intelligently target viewers with relevant advertisements.

The advertising models utilize data mining techniques and can be built using tools such as Microsoft's SQL Server Analysis System (MS SSAS). The advertising models are created using a well-known data mining algorithm such as Naïve Bayes, Decision Trees, Logistic Regression analysis, and Association Rules, and may also use large scale clustering, all of which are available in MS SSAS.

The playback of multimedia content on a digital sign is accomplished through a content management system (CMS). A description follows of the architecture of a digital sign advertising system in accordance with an embodiment of the invention, in which advertising models are deployed in real time on a digital sign through the CMS, even when the CMS is located “in the cloud”. The CMS can then be used to generate a customized advertising list based on at least two parameters: a trained advertising model, and advertising data. According to an embodiment of the invention, the advertising data is combined with the trained advertising model to enable real-time content triggering.

Embodiments of the invention analyze the type of viewer information, such as age, in particular, an age range or age bracket, and gender, as well as contextual information, such as location, weather and time information, to select the most appropriate advertisement to be played on the digital sign display device. In one embodiment, the invention analyzes an object associated with a viewer, for example, a vehicle in which the viewer is traveling, or a pair of shoes the viewer is wearing, and determines the type the object, such as a sedan, or a pair of running shoes. Further, an embodiment attempts to determine features or characteristics of the object, such as the make and model of a vehicle, or a logo on the pair of shoes. Further references herein to “age” shall be understood to include an age range, category or bracket.

Real time video analytics data is collected and analyzed to predict the type of viewers for a future time slot, for example, the next time slot. In one embodiment, the next time slot is 30 seconds. However, the time slot could be 60 seconds, 30 minutes, one hour, or an even greater length of time. Depending on the prediction, appropriate ads are played on a display device. The CMS generates a default play list by using advertising information and advertiser preference. If viewership information is not available or the prediction is for some reason not made or not reasonably accurate or if for some reason the accuracy of the prediction is considered suspect, then an offline (default) play list generated by CMS may be played on the display device.

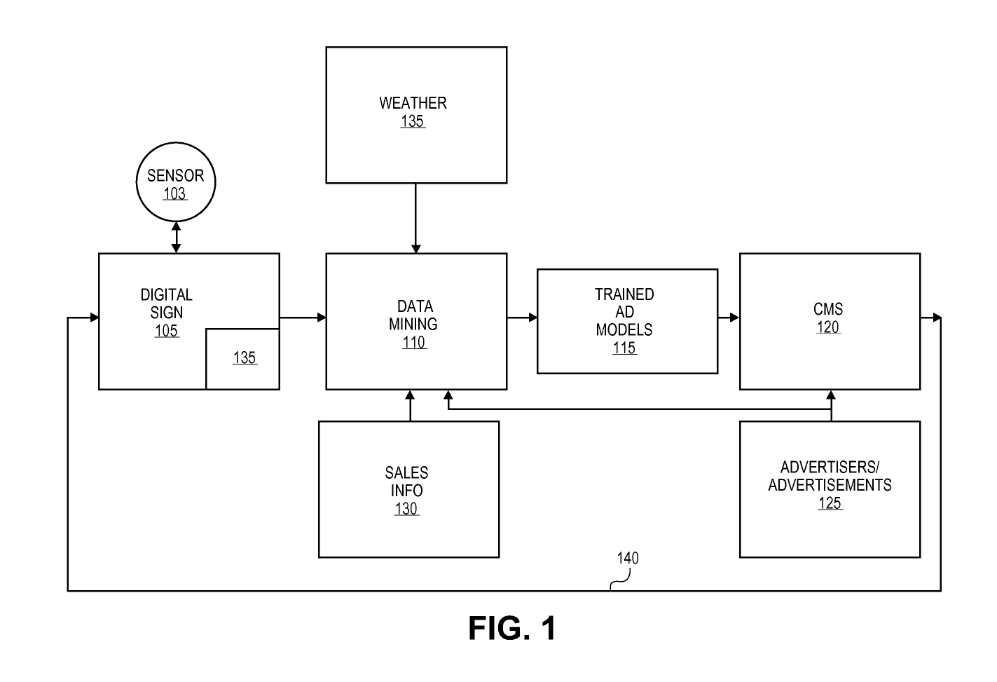

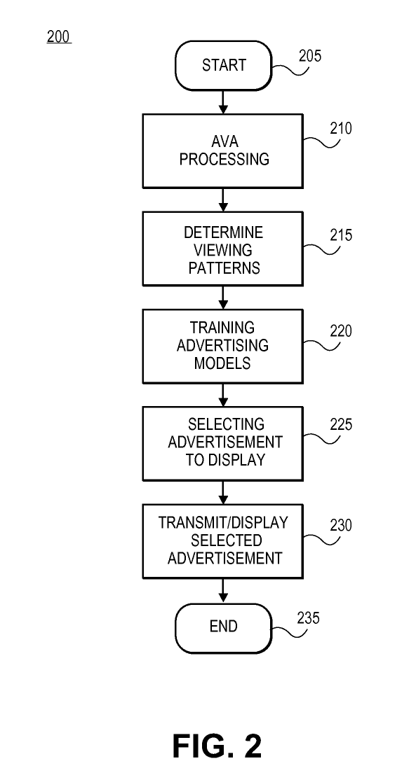

FIG. 1 illustrates a functional block diagram of an embodiment of the invention. With reference also to the flow chart 200 in FIG. 2, the process starts at 205 with digital sign module 105 displaying advertisements. The process continues with processing video analytic data at 210, that is, capturing video analytic data, also referred to herein as viewership data, and sending the viewership data to a permanent data store, such as a database. At the permanent store, the data is optionally cleaned or filtered before being accessed at 215 by the data mining module 110 to determine viewing patterns of any individuals located in front of the digital sign and capable of viewing the same.

The data capture functionality may be embodied in software executed by the digital sign module, and in one embodiment of the invention, captures real time video analytic data that may be used by data mining module 110 to make real time predictions and schedule a digital advertisement for display, and/or may be used as historical data for generating rules (training advertising models) in the data mining module at 220.

In the data mining module, the advertising models are generated and trained (that is, refined) at 220 using the video analytic data based on well-known data mining algorithms, such as the Naive Bayes algorithm, the Decision Trees algorithm, Logistic Regression analysis, and the Association Rules algorithm. In addition to using the video analytic data, the data mining module may also consider contextual information such as the weather conditions corresponding at the time the video analytic data was captured. Weather conditions data, or simply, weather data 135, may be maintained in a permanent store that can be accessed by data mining module 110. In one embodiment, the same permanent store may be used to store the video analytic data captured by the digital sign module 105 as well. Further, data mining module 110 receives as input a list of digital advertisements 125 available for display on the digital sign, and metadata associated the list of advertisements, such as the demographic characteristics of viewers to which advertisers wish to target their advertisements. Digital sign module 105 also supplies to the data mining module “proof-of-play” data, that is, advertising data indicating what ads were displayed by the digital sign, when those ads where displayed, and where those ads were displayed (e.g., by providing a device identifier (ID) for the digital sign that can be used as a basis for determining the location of the digital sign). In one embodiment of the invention, sales data 130, for example, from a Point-of-Sale terminal, may be input to data mining module 110. The sales data may be correlated with the VA data to gauge the effectiveness of an advertisement on a certain demographic group in terms of the sale of products or services featured in the advertisement.

The data mining module 110 generates at 220 trained advertising models which according to an embodiment of the invention are used to predict suitable advertising categories as well as future viewer types based on previous viewer types (“passer pattern types”). Once a trained advertising model 115 is generated it is transmitted by the data mining module and received and stored by the content management system (CMS) 120 where along with advertising data, a customized advertising list is generated and stored at 225. In one embodiment, the CMS stores all trained advertising models, advertisement lists, advertiser preferences, and advertising data. CMS 120 transmits the customized advertising list through communication link 140 to digital sign module 105 for display. In one embodiment of the invention, digital sign module 105 comprises a digital signage media player module (digital player module) 145, which may be used to generate the advertising lists in real time. Module 145 operates as a condensed repository for information stored in the CMS, according to one embodiment of the invention.

The CMS obtains trained advertising models from the data mining module. In one embodiment, multiple digital sign modules 105, or multiple digital signage media players 145, or multiple digital display devices are installed. The CMS therefore will segregate the advertising models by digital sign module, or digital player, etc., as the case may be. The CMS generates segregated customized ad lists based on the advertising models and obtained advertising data. The CMS also generates offline ad lists, that is, default ad lists, based on advertiser preferences obtained from advertisers 125. These segregated models, customized ad lists, and default ad lists are sent to each digital sign module or digital player at 230 for display on the digital sign.

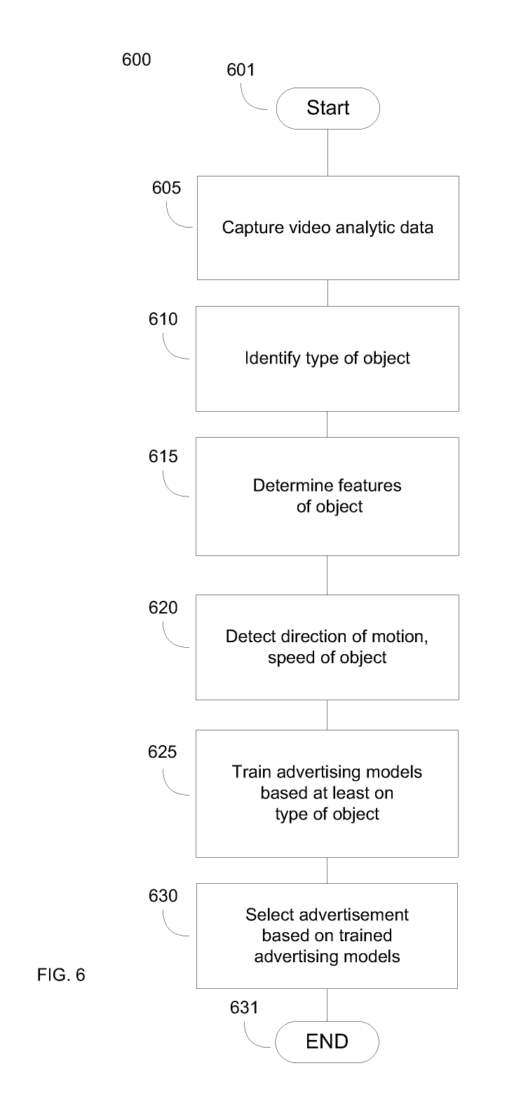

Another embodiment of the invention is now described with reference to flow chart 600 in FIG. 6. The process starts at 601 with digital sign module 105 displaying advertisements and processing video analytic data at 605, that is, capturing video analytic data, also referred to herein as viewership data, and sending the viewership data to a permanent data store, such as a database, where the data is optionally cleaned or filtered before being accessed at 610 by the data mining module 110 to determine objects associated with viewers from the video analytic data, as well as the types of those objects, if possible. In one embodiment, one or more sensors 103 such as a camera capture the video analytic data when viewers and/or their associated objects are within range of the cameras. The cameras may be remotely located relative to the digital sign module. For example, a camera may be coupled to a neighboring or distant digital sign module, and video feed or screen shots captured from the camera coupled to the neighboring or distant digital sign module may be provided to the local digital sign module and/or a permanent store accessible to the digital sign module, via a communications network. Consider, for example, a series of digital sign modules operating as billboards along a freeway, wherein each digital sign module has one or more cameras coupled thereto. In one embodiment, the object being captured by the camera may obscure the viewer, for example, the object may be a vehicle such as an automobile. In another embodiment, the object may be an article worn by viewer, for example, a pair of shoes, a pair of pants, a shirt, eyeglasses, or a hat, worn by the viewer.

In one embodiment, object detection or recognition functionality is provided by an object detection algorithm that incorporates deformable parts modeling, such as the latent, i.e., hidden, Support Vector Machine (SVM) algorithm, operating in conjunction with a processor and the camera. Various types of objects may also be detected and differentiated, for example, a bicycle, a motorcycle, an automobile, or a tractor-trailer. In one embodiment of the invention, this object information, whether identification of an object, or the type of object identified, or both, may be used to train advertising models at 625.

Further, in one embodiment, features or characteristics of an object may be detected at 615. For example, a manufacturer of an automobile, or the identity or origin of a graphic symbol or trademark on a baseball cap may be detected. In one embodiment, an algorithm executed by a processor operating in conjunction with the camera provides feature recognition functionality. For example, key point recognition using a Ferns algorithm identifies a set of key points of an image and compares the set to a set of key points of a test image. In this manner, a logo, for example, on a car, or on a hat, can be identified. In one embodiment of the invention, this feature information relating to an object may also be used to train advertising models at 625.

Finally, an object may be tracked at 620 to determine a direction and speed of motion. For example, an object, such as a car, may be tracked over a series of consecutive images captured over fixed intervals of a period of time, to determine the direction and speed of direction of the object. In one embodiment, an algorithm executed by a processor operating in conjunction with the camera provides the object tracking function. For example, a Lucas Kanade algorithm may be used to track the object among the images. The algorithm can be used to determine the speed of each object in the series of images, as well as the average speed of objects appearing in the images, such as the average speed of vehicles appearing in the images. This average speed information may be used to estimate the approximate time that objects, e.g., cars, are going to come into a viewing range of an approaching digital sign. In one embodiment, this tracking information, whether direction of motion, or speed of motion, or both, may also be used to train the advertising models, and an appropriate advertisement from an advertisement playlist is selected at 630 by, and displayed on, the approaching the digital sign.

The data capture functionality may be embodied in software executed by the digital sign module, and in one embodiment of the invention, captures real time video analytic data that may be used by data mining module 110 to make real time predictions and schedule a digital advertisement for display, and/or may be used as historical data for generating rules (training advertising models) in the data mining module at 625.

In the data mining module, the advertising models are generated and trained (that is, refined) at 625 using the video analytic data based on well-known data mining algorithms, such as the Naïve Bayes algorithm, the Decision Trees algorithm, Logistic Regression analysis, and the Association Rules algorithm. In addition to using the video analytic data, the data mining module may also consider contextual information such as the weather conditions corresponding at the time the video analytic data was captured. Weather conditions data, or simply, weather data 135, may be maintained in a permanent store that can be accessed by data mining module 110. In one embodiment, the same permanent store may be used to store the video analytic data captured by the digital sign module 105 as well. Further, data mining module 110 receives as input a list of digital advertisements 125 available for display on the digital sign, and metadata associated the list of advertisements, such as the demographic characteristics of viewers to which advertisers wish to target their advertisements. Digital sign module 105 also supplies to the data mining module “proof-of-play” data, that is, advertising data indicating what ads were displayed by the digital sign, when those ads where displayed, and where those ads were displayed (e.g., by providing a device identifier (ID) for the digital sign that can be used as a basis for determining the location of the digital sign). In one embodiment of the invention, sales data 130, for example, from a Point-of-Sale terminal, may be input to data mining module 110. The sales data may be correlated with the VA data to gauge the effectiveness of an advertisement on a certain demographic group in terms of the sale of products or services featured in the advertisement.

The data mining module 110 generates at 625 trained advertising models which according to an embodiment of the invention are used to predict suitable advertising categories. Once a trained advertising model 115 is generated it is transmitted by the data mining module and received and stored by the content management system (CMS) 120 where along with advertising data, a customized advertising list is generated and stored at 630. In one embodiment, the CMS stores all trained advertising models, advertisement lists, advertiser preferences, and advertising data. CMS 120 then transmits the customized advertising list to digital sign module 105 for display. In one embodiment of the invention, digital sign module 105 comprises a digital signage media player module (digital player module) 145, which may be used to generate the advertising lists in real time. Module 145 operates as a condensed repository for information stored in the CMS, according to one embodiment of the invention.

The CMS obtains trained advertising models from the data mining module. In one embodiment, multiple digital sign modules 105, or multiple digital signage media players 145, or multiple digital display devices are installed. The CMS therefore will segregate the advertising models by digital sign module, or digital player, etc., as the case may be. The CMS generates segregated customized ad lists based on the advertising models and obtained advertising data. The CMS also generates offline ad lists, that is, default ad lists, based on advertiser preferences obtained from advertisers 125. These segregated models, customized ad lists, and default ad lists are sent to each digital sign module or digital player for display on the digital sign.

### Targeted Advertising

The point of targeted advertising is to show a future audience certain advertisements that have, or likely have, in the past been viewed for a reasonable amount of time by a previous audience having the same or similar demographics as the future audience. The process of targeted advertising according to an embodiment of the invention can be characterized in three phases and corresponding components of the digital advertising system according to an embodiment of the invention: learning, or training, advertising models in the data mining module 110, creating customized ad lists, or playlists, in the CMS 120, and playing the playlists with a digital sign module 105.

### A. Learning Advertising Models

Data mining technology involves exploring large amounts of data to find hidden patterns and relationships between different variables in the dataset. These findings can be validated against a new dataset. A typical usage of data mining is to use the discovered pattern in the historical data to make a prediction regarding new data. In embodiments of the invention, the data mining module 110 is responsible for training and querying advertising models. In particular, two types of advertising models are generated, an advertising category (ad category) model, and a passer pattern model. In the ad category model, a set of rules is correlated with the most appropriate ad category for a particular audience or context (e.g., time, location, weather).

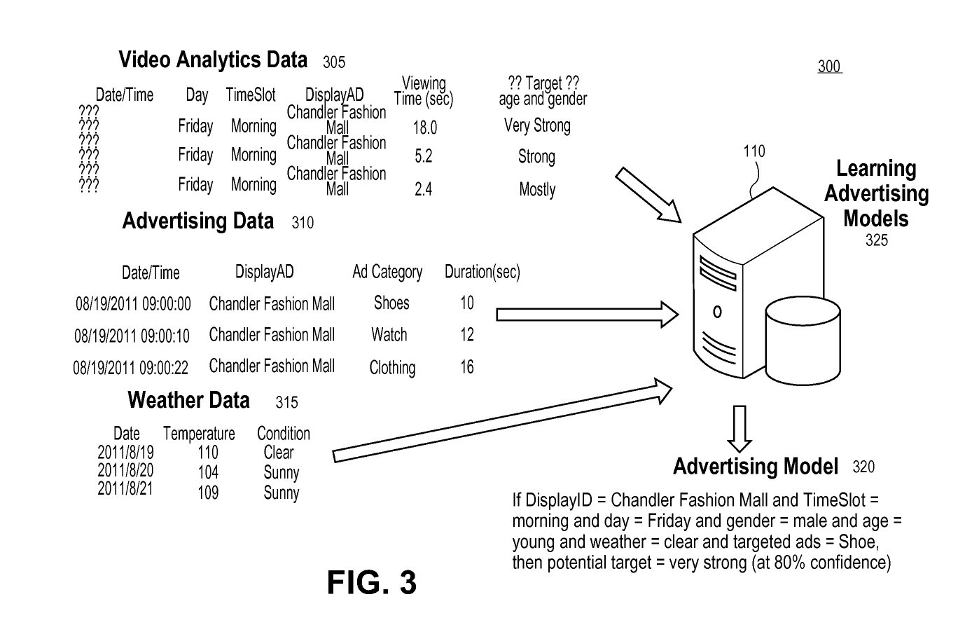

FIG. 3 provides an illustration 300 of the video analytic data 305 gathered by the digital sign module 105 and provided as input to the data mining module 110 along with advertising data 310, and weather data 315 also provided as input to the data mining module. At 325, the data mining module, in one embodiment, generates and trains, that is, refines, models 320 on a regular basis, whether daily, weekly, monthly, or quarterly, depending on the context and data characteristics, the basic principle being that if the patterns/rules derived from historical data don't change, there is no immediate need to train or regenerate models.

Video analytic data 305, according to one embodiment of the invention, comprises the date and time a particular digital advertisement was displayed on the digital sign, as well the day the ad was displayed, a device ID or alternatively a display ID that indicates a location at which the ad was displayed. Sensor input may also provide the amount of time that the digital ad was viewed while being displayed on the digital display device, in one embodiment. Finally, an indication of the potential target viewership based on characteristics such as age and gender is included.

Advertising data 310, received by data mining module 110 from the advertisements repository 125, includes the date and time a particular digital advertisement was scheduled for display on the digital sign, as well a device ID or alternatively a display ID that indicates a location at which the ad was scheduled to be displayed, and a duration or length of the digital advertisement, in seconds. Weather data 315 includes the date, temperature, and conditions on or around the date and time the digital advertising was displayed on the digital sign.

### B. Creating an Advertising List

After the advertising models are generated by data mining module 110, the models are transferred to the Content Management System (CMS) 120. The CMS then extracts the ad categories from the ad category models and creates an ad category list. The advertising data corresponding to these ad categories are then retrieved from a permanent store, such as a database, accessible to CMS 120. Based on the ad category list, CMS 120 also creates advertisement lists. In one embodiment of the invention, a generated ad list may be modified based on advertiser input at 125. In one embodiment, each advertiser is assigned a certain priority that can be used as a basis for rearranging the ad list.

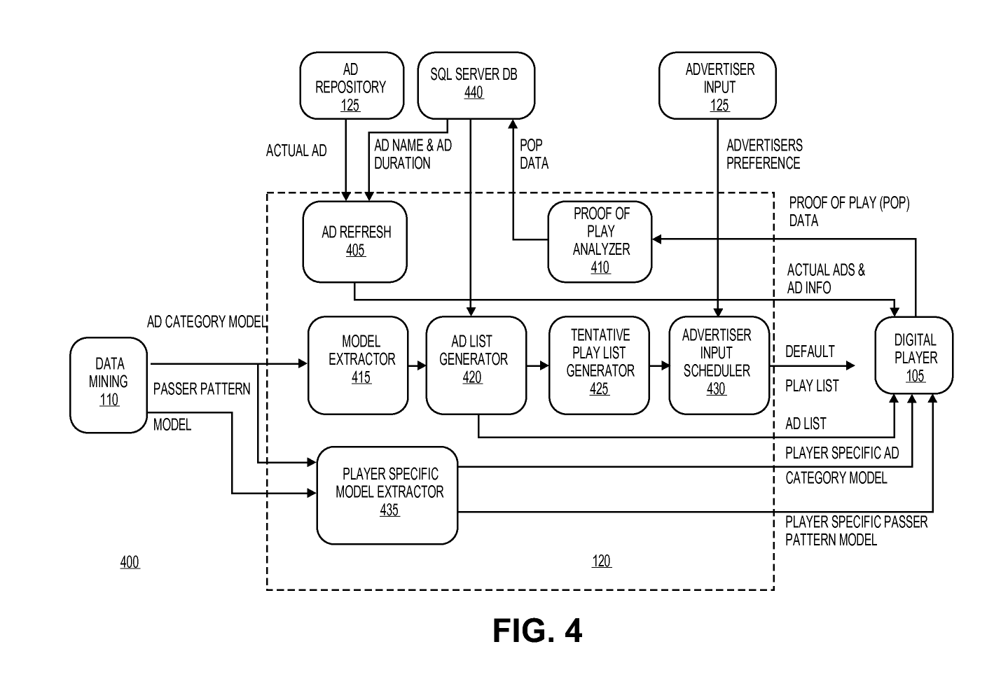

FIG. 4 illustrates the flow of events and information 400 in the CMS 120. The CMS probes the data mining module 110. The frequency of probing in one embodiment of the invention is once a day, according to one embodiment of the invention. The CMS gets all the current rules and predictive lists generated by the data mining module and stores the information in a permanent store. Advertisements corresponding to particular categories are obtained from the tentative playlist based on advertiser preferences, the ad list generator, and advertisement repository 125. In “offline mode” the tentative playlist is used as the default playlist. A data store, such as the Structured Query Language (SQL) server database depicted in FIG. 4, is associated with the advertisements repository 125, according to one embodiment. From that data store various information is retrieved including advertising data for the particular categories such as the advertising name, the advertising type, and a path in a file directory of the ad repository that holds the files for the actual advertisements. The CMS connects to the advertising repository to get the advertisements located at the given paths. All the models and the corresponding advertising lists generated so far get stored at the CMS. A digital sign module typically will only contain a subset of these models and advertising lists that are suitable for the digital sign module's targeted audience. The CMS connects to the digital sign module and pushes to it the models and advertising lists suitable for it.

Referring again to FIG. 4, the Player Specific Model Extractor 435 connects to the data mining module 110, and obtains both the passer pattern type and ad category models. These models are segregated per player and sent to digital sign module (digital player) 105. Data mining module 110 provides models that are suitable for the current day and date as well as the current weather, for example, the current day is Friday Mar. 9, 2012, with a forecasted clear morning and a rainy evening. The model extractor 415 extracts the ad categories from ad category models and sends such to the ad(vertising) list generator 420 for each digital sign. The models are parsed and an advertisement is selected for each time slot. For example, assuming that the average advertisement duration is 10 seconds, 360 advertisements are selected for each hour.

The ad list generator 420 fetches ads for the categories that are scheduled for a particular day, along with the advertising data. The tentative play list generator module 435 analyzes the ad list and generates a tentative play list that is sent to the advertiser input scheduler 430. Generator 420 compiles a play list based on arranged advertising categories, and an advertising list. The selection of advertisements is based on the roulette-wheel selection, according to one embodiment, where each advertisement is randomly picked based on a probability. The advertiser input scheduler module 420 fetches advertiser input and incorporates advertiser preferences in the tentative play list to generate the default play list which is sent to the digital sign module.

The ad refresh module 405 checks for new advertisements by comparing the versions maintained in a permanent store, e.g., a database, accessible to the CMS against versions obtained from the advertisements repository. If a new version of an advertisement is found then the actual advertisements (video files) are transferred to the digital sign module. If new ads (ads which were not present earlier in the ad repository) are present then module 405 fetches advertising data from SQL server DB 440 and sends such to the digital sign module 105. In one embodiment, proof-of-play analyzer 410 keeps track of which advertisements were played, at what time, at what location and who were the audience for those advertisements.

### C. Playing Playlist with Digital Sign Module

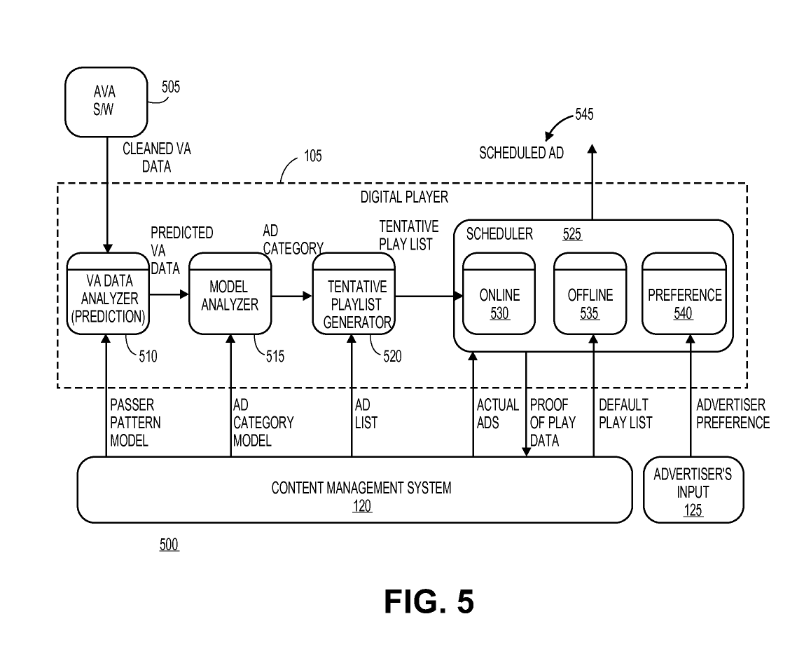

CMS 120 transfers the ad list through communication link 140 to the digital sign module 105. In one embodiment, digital sign module generates a default playlist by extracting file directory path information from the ad list and then retrieving the corresponding advertisements from an advertisements repository 125 that holds the advertisement files. The digital sign module operates in both an online and an offline mode. In the offline mode, the default playlist is played to the digital sign. The playlist for the online mode is generated using the real time VA data described below with reference to FIG. 5 which illustrates the flow of events and information 500 in the digital sign module (digital player) 105.

The video analytic (VA) analyzer (predictor) module 510 fetches real time VA data 505 and retrieves passer pattern models from CMS 120 to predict VA data 510. The predicted VA data 510 is sent to model analyzer module 515. The model analyzer module 515 receives the predicted VA data as input and retrieves ad category models from CMS 120 and extracts an advertising category based on the predicted VA data. In one embodiment, confidence values of the passer pattern model and the ad category model are multiplied to generate a multiplied confidence value. If the multiplied confidence value is greater than a threshold, then an advertisement for the extracted advertising category is sent to the tentative play list generator 520, otherwise the digital sign module continues in an offline mode. The tentative play list generator module 520 retrieves an advertising list from CMS 120 and generates the tentative play list by considering the advertising category from the model analyzer and sends the tentative play list to online mode.

Scheduler module 525 contains the three sub-modules: an online sub-module 530 that selects an advertisement based on a probability distribution and associates it with an actual advertisement that is then scheduled and sent to display at 545; an offline sub-module 535 that selects an advertisement from a default play list based on the scheduling time and associates it with an actual advertisement that is then scheduled and sent to display at 545; and a preference sub-module 540 that checks for an advertiser preference and schedules an advertiser preferred advertisement for display at 545.

### Real Time Content Triggering

According to an embodiment of the invention, viewers are targeted in real time. The real time processing takes place at the digital sign module. Each digital sign module receives both an advertising category as well as passer pattern models from the CMS. Broadly speaking, according to one embodiment, a plurality of viewers is detected, the demographics of those viewers are analyzed, and viewing patterns for those viewers is collected. Based thereon, advertisements are targeted to the digital sign module. In one embodiment, the passer pattern model has a parameter referred to as the confidence value that indicates whether to play digital advertisements in online mode or offline mode. Thus, when the AVA data is analyzed in real time mode, the rules from the passer pattern model are chosen and the confidence value attached to these rules is compared with a threshold value. If the confidence value falls short of the threshold, then the default playlist is played, but if the value is the same or greater than the threshold, then the advertisements list is modified and advertisements targeting current viewers are played. After the current advertisement is played, either the digital sign module can return to playing the default playlist or could continue playing targeted advertisements.

### Data Mining for Targeted Advertising

Data mining technology involves exploring large amounts of data to find hidden patterns and relationship between different variables in the dataset. Embodiments of the invention use data mining algorithms to discover the patterns on viewing behaviors of the audience. The basic idea is to show a future audience certain ads that have in the past been viewed for a reasonable amount of time by the audience belonging to the same demographics.

### A. Multiple Advertising Model Training

For the purpose of capturing the patterns contained in the viewership data, two embodiments are used to retrain the advertising models: regular retraining and on demand retraining. Regular retraining is triggered regularly, such as weekly or monthly. On-demand retraining is triggered when the performance of the advertising models is lower than a predefined threshold or a retaining request is received from users or operators. In one embodiment, to fully take use of the advantages of different data mining algorithms, multiple data mining algorithms, including Decision Tree, Association Rule and Naive Bayes, and Logistic Regression analysis are used to train advertising models in parallel. The best advertising model or multiple advertising models is used for ad selection.

### B. Audience Targeting Methods

### 1. Seeing Based Targeting

Seeing based targeting refers to targeting an audience based on the digital sign “seeing” the audience. Demographic information is obtained from the digital sign's sensor, such as one or more front-facing cameras proximate the digital display device. The sensor, and AVA software coupled with processors provide embodiments to anonymously detect the number of viewers, their gender, and their age bracket, and then adapt ad content based on that information. For example, if three young females and one senior male are seen passing by the digital sign, then the advertising models are queried using this information as input, and the most appropriate ad is selected to play.

### 2. Prediction Based Targeting

Prediction based targeting first predicts the viewers, or passers, arriving at the digital sign in a future period of time and then targets them. For example, if it is predicted that three young females and one senior male will pass by the digital sign within the next 20 seconds, then an appropriate ad, for example, the most appropriate ad, is selected per the advertising models and prepared to play.

### 3. Context Based Targeting

Context based targeting targets ads depending on the context, such as date/time, digital sign location, weather information, etc. For example, on a clear Wednesday morning between 9 AM and 11 AM during November and December, an ad for senior males may be selected to play on a particular digital sign according to the advertising models. This embodiment is useful when the passer type prediction based targeting is not reliable or no passer patterns are, or can be, discovered from the viewership data.

The following examples pertain to further embodiments of the invention.

One embodiment involves a method for selecting when to display one of a plurality of advertisements on a digital sign, comprising: gathering video analytics data from a plurality of objects that pass by a sensor; analyzing the gathered video analytics data to determine a type for each of the objects; training advertising models based on the determined types; and selecting an advertisement from a plurality of advertisements for display on the digital sign based on the trained advertising models. According to the embodiment, one of a plurality of viewers is associated with a respective one of the plurality of objects that pass by the sensor, and wherein selecting the advertisement for display on the digital sign comprises selecting the advertisement for display on the digital sign for viewing by a viewer associated with the object. One embodiment further comprises analyzing the gathered video analytics data for the purpose of determining a feature for each of the objects, and further training advertising models based on the determined features. One embodiment further comprises analyzing the gathered video analytics data to determine a direction of motion for each of the objects, and further training the advertising models based on the direction of motion of the objects.

One embodiment of the invention comprises analyzing the gathered video analytics data to determine a speed for each of the objects, and further training the advertising models based on the speed of the objects.

One embodiment of the invention further comprises receiving advertiser preferences as to which advertisement to display on the digital sign, and wherein selecting the advertisement for display on the digital sign based on the trained advertising models comprises selecting the advertisement for display based on the trained advertising models and the advertiser preferences.

One embodiment of the invention further comprises receiving advertising data corresponding to the advertisements displayed on the digital sign; and wherein training advertising models based on the determined types comprises training advertising models based on the determined types and the advertising data. The advertising data comprises a date and time, a display location, an ad category, and a duration or length or time for each advertisement displayed on the digital sign.

According to one embodiment, the digital advertising system comprises an input to receive a plurality of digital advertisements; an output via which to transmit the digital advertisements for display on a digital sign module; a plurality of objects that pass by a sensor and generate trained advertising models based on the video analytics data according to a data mining algorithm; and a content management system module coupled to the data mining module to receive the trained advertising models, and to the input to receive the plurality of digital advertisements, the content management system to generate and transmit to the digital sign module a subset of the plurality of advertisements for display based on the trained advertising models and the plurality of digital advertisements.

One embodiment further comprises an advertisements module coupled to the input to provide the plurality of digital advertisements. One embodiment further comprises the digital sign module coupled to the output to receive the digital advertisements, the digital sign module to display the digital advertisements and to capture and transmit to a permanent store the video analytics data.

One embodiment further comprises the data mining module coupled to the permanent store to retrieve the video analytics data. The data mining module generates trained advertising models based on the video analytics according to one of a number of well-known data mining algorithms including a Naïve Bayes, a Decision Trees, and an Association Rules, data mining algorithm.

In one embodiment, the digital sign module comprises a digital sign player module in which to store, and from which to transmit to a digital display screen, the subset of the plurality of advertisements for display.

In one embodiment the input further receives advertiser preferences as to which advertisement to transmit to the digital sign, and the content management system generates and transmits to the digital sign module a subset of the plurality of advertisements for display based on the trained advertising models, the plurality of digital advertisements, and the advertiser preferences.

According to one embodiment, the data mining module couples to the digital sign module to retrieve video analytics data and advertising data corresponding to display of the advertisements transmitted for display to the digital sign, and generates trained advertising models based on the video analytics data and the advertising data according to the data mining algorithm.

In one embodiment, the video analytics data comprises one or more object types and features. The one or more object types and features comprises a type of vehicle, a make of a vehicle, a model of a vehicle, a direction of motion of the vehicle, and a speed at which the vehicle moves in the direction of motion.

In one embodiment, the video analytics data further comprises one or more of a date and time, a day-of-the-week, a timeslot, and a location.

### CONCLUSION

In this description, numerous details have been set forth to provide a more thorough explanation of embodiments of the present invention. It should be apparent, however, to one skilled in the art, that embodiments of the present invention may be practiced without these specific details. In other instances, well-known structures and devices have been shown in block diagram form, rather than in detail, in order to avoid obscuring embodiments of the present invention.

Some portions of this detailed description are presented in terms of algorithms and symbolic representations of operations on data within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from this discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such

Embodiments of present invention also relate to apparatuses for performing the operations herein. Some apparatuses may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, DVD-ROMs, and magnetic-optical disks, read-only memories (ROMs), random access memories (RAMs), EPROMs, EEPROMs, NVRAMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems appear from the description herein. In addition, embodiments of the present invention are not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

Whereas many alterations and modifications of the embodiment of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims that recite only those features regarded as essential to the invention.

1. A method for selecting when to display one of a plurality of advertisements on a digital sign, comprising:
gathering video analytics data from a plurality of objects that pass by a sensor;
analyzing the gathered video analytics data to determine a type for each of the objects;
training advertising models based on the determined types; and
selecting an advertisement from a plurality of advertisements for display on the digital sign based on the trained advertising models.

2. The method of claim 1, wherein one of a plurality of viewers is associated with a respective one of the plurality of objects that pass by the sensor, and wherein selecting the advertisement for display on the digital sign comprises selecting the advertisement for display on the digital sign for viewing by a viewer associated with the object.

3. The method of claim 1, further analyzing the gathered video analytics data for the purpose of determining a feature for each of the objects, and further training advertising models based on the determined features.

4. The method of claim 1, further comprising analyzing the gathered video analytics data to determine a direction of motion for each of the objects, and further training the advertising models based on the direction of motion of the objects.

5. The method of claim 1, further comprising analyzing the gathered video analytics data to determine a speed for each of the objects, and further training the advertising models based on the speed of the objects.

6. The method of claim 1, further comprising receiving advertiser preferences as to which advertisement to display on the digital sign, and wherein selecting the advertisement for display on the digital sign based on the trained advertising models comprises selecting the advertisement for display based on the trained advertising models and the advertiser preferences.

7. The method of claim 1, wherein the video analytics data further comprises one or more of a date and time, a day-of-the-week, a timeslot, and a location.

8. The method of claim 1, further comprising:
receiving advertising data corresponding to the advertisements displayed on the digital sign; and
wherein training advertising models based on the determined types comprises training advertising models based on the determined types and the advertising data.

9. (canceled)

10. A digital advertising system, comprising:
an input to receive a plurality of digital advertisements;
an output via which to transmit the digital advertisements for display on a digital sign module;
a data mining module to couple to the digital sign module to retrieve video analytics data relating to a plurality of objects that pass by a sensor and generate trained advertising models based on the video analytics data according to a data mining algorithm; and
a content management system module coupled to the data mining module to receive the trained advertising models, and to the input to receive the plurality of digital advertisements, the content management system to generate and transmit to the digital sign module a subset of the plurality of advertisements for display based on the trained advertising models and the plurality of digital advertisements.

11. The digital advertising system of claim 10, further comprising an advertisements module coupled to the input to provide the plurality of digital advertisements.

12. The digital advertising system of claim 10 further comprising the digital sign module coupled to the output to receive the digital advertisements, the digital sign module to display the digital advertisements and to capture and transmit to a permanent store the video analytics data.

13. The digital advertising system of claim 12, further comprising the data mining module coupled to the permanent store to retrieve the video analytics data.

14. The digital advertising system of claim 13, wherein the data mining module generates trained advertising models based on the video analytics according to one of a number of well-known data mining algorithms including a Naïve Bayes, a Decision Trees, and an Association Rules, data mining algorithm.

15. The digital advertising system of claim 14, wherein the digital sign module comprises a digital sign player module in which to store, and from which to transmit to a digital display screen, the subset of the plurality of advertisements for display.

16. The digital advertising system of claim 10, wherein the input further receives advertiser preferences as to which advertisement to transmit to the digital sign, and wherein the content management system to generate and transmit to the digital sign module a subset of the plurality of advertisements for display based on the trained advertising models, the plurality of digital advertisements, and the advertiser preferences.

17. The digital advertising system of claim 10, wherein the data mining module to couple to the digital sign module to retrieve video analytics data and advertising data corresponding to display of the advertisements transmitted for display to the digital sign, and generate trained advertising models based on the video analytics data and the advertising data according to the data mining algorithm.

18. The digital advertising system of claim 10, wherein the video analytics data comprises one or more object types and features.

19. (canceled)

20. The digital advertising system of claim 12, wherein the video analytics data further comprises one or more of a date and time, a day-of-the-week, a timeslot, and a location.

21. At least one machine readable medium comprising a plurality of instructions that in response to being executed on a computing device, cause the computing device to:
gather video analytics data from a plurality of objects that pass by a sensor;
analyze the gathered video analytics data to determine a type for each of the objects;
train advertising models based on the determined types; and select an advertisement from a plurality of advertisements for display on the digital sign based on the trained advertising models.

22. The at least one machine readable medium of claim 21, wherein one of a plurality of viewers is associated with a respective one of the plurality of objects that pass by the sensor, and wherein to select the advertisement for display on the digital sign comprises to select the advertisement for display on the digital sign for viewing by a viewer associated with the object.

23. The at least one machine readable medium of claim 21, further to analyze the gathered video analytics data for the purpose of determining a feature for each of the objects, and further to train advertising models based on the determined features.

24. The at least one machine readable medium of claim 21, further comprising to analyze the gathered video analytics data to determine a direction of motion for each of the objects, and further to train the advertising models based on the direction of motion of the objects.

25. The at least one machine readable medium of claim 21, further comprising to analyze the gathered video analytics data to determine a speed for each of the objects, and further to train the advertising models based on the speed of the objects.

26. The at least one machine readable medium of claim 21, further comprising to receive advertiser preferences as to which advertisement to display on the digital sign, and wherein to select the advertisement for display on the digital sign based on the trained advertising models comprises to select the advertisement for display based on the trained advertising models and the advertiser preferences.

27. The at least one machine readable medium of claim 21, further comprising:
to receive advertising data corresponding to the advertisements displayed on the digital sign; and
wherein to train advertising models based on the determined types comprises to train advertising models based on the determined types and the advertising data.

28. (canceled)
